(19) United States
(12) Patent Application Publication
(10) Pub. No.: US 2014/0358882 A1
(43) Pub. Date: Dec. 4, 2014

(54) DEVICE CONTENT USED TO BIAS A SEARCH INFRASTRUCTURE

(71) Applicant: Broadcom Corporation, Irvine, CA (US)

(72) Inventor: Wael William Diab, San Francisco, CA (US)

(73) Assignee: Broadcom Corporation, Irvine, CA (US)

(21) Appl. No.: 13/907,440

(22) Filed: May 31, 2013

Related U.S. Application Data
(60) Provisional application No. 61/827,840, filed on May 28, 2013.

(51) Int. Cl. G06F 17/30

(52) U.S. Cl. CPC G06F 17/30864
USPC 707/707; 707/706

(57) ABSTRACT

Biasing of search query inputs based on local content, device profile and/or activity information. In various embodiments, biasing operations are performed on a search input to a client device in order to improve search result relevancy. The biasing operations produce additional search query elements/context options based on locally-hosted content or other information that may not be readily available to a search engine. The local content may include, for example, images, text, audio/video files, documents, code, applications, social media, etc. One or more of additional search query elements/context options produced by the biasing operations are then utilized in a search query communicated to a search engine. In various alternate embodiments, device activity data extracted from a user's device (such as data generated by device sensors) may likewise be employed to refine search queries. In further embodiments, searching and biasing operations may be performed by an intermediary or proxy device.

### CROSS REFERENCE TO RELATED PATENTS/PATENT APPLICATIONS

### Provisional Priority Claims

The present U.S. Utility patent application claims priority pursuant to 35 U.S.C. §119(e) to the following U.S. Provisional Patent Application which is hereby incorporated herein by reference in its entirety and made part of the present U.S. Utility patent application for all purposes:

1. U.S. Provisional Patent Application Ser. No. 61/827,840, entitled “DEVICE CONTENT USED TO BIAS A SEARCH INFRASTRUCTURE,” filed May 28, 2013, pending.

### BACKGROUND

1. Technical Field

The disclosure relates generally to search engine infrastructures, including biasing of search operations based on locally-hosted device content.

2. Description of Related Art

A vast and ever-increasing amount of information, documents and other resources are available via the Internet. In order to access such resources, a keyword-based search query is typically entered into a search engine interface or web browser on a client device such as a laptop computer, smartphone, tablet device, web-enabled television, set top box (STB), etc. The search engine then examines its index/search databases, and presents a set of search results (or “web documents”). These search results are typically ranked by algorithms employed by the search engine, such that the “best” results are presented first. Each result in a listing of search results may include a short summary containing a web document's title and excerpts of text in order to suggest its relevancy.

In order to generate and maintain search databases, conventional search engine infrastructures employ web crawlers (also known as “spiders”) that examine or “crawl” web hosting servers to gather web page text and associated media content. A typical web crawler follows every link on a given web page. The contents of such pages are analyzed for purposes of indexing and extracting search database content for use in responding to search queries.

Various techniques have been implemented or proposed for improving the quality and ranking of presented search results. For example, a search engine provider may collect and store information relating to a particular user, including previously submitted search inquiries and browsing history, for use in influencing the manner in which search results are presented. Other behavioral information tracked by a search engine provider may be utilized, such as user clicks on previous search result pages and advertisements from search result pages.

### BRIEF DESCRIPTION OF THE SEVERAL VIEWS OF THE DRAWINGS

FIG. 1 shows an exemplary network employing search result biasing functionality.

FIG. 2 is a block diagram of one example of a search system.

FIG. 3 is a state diagram depicting exemplary user interaction with a search infrastructure.

FIG. 4 illustrates an exemplary search engine infrastructure employing search context pre-processing.

FIG. 5 is an operational flow diagram illustrating an exemplary method for utilizing device content to bias a search query.

FIG. 6 is an operational flow diagram illustrating an exemplary method for interactively biasing a search query with locally-hosted content.

FIG. 7 is a functional block diagram representation of an exemplary residential network supporting search query biasing operations.

FIG. 8 is a schematic block diagram of an example client device supporting search query biasing operations.

FIG. 9 is a screen shot illustrating an exemplary search query interface supporting user-specified biasing operations.

### DETAILED DESCRIPTION

In various embodiments of the technology described herein, search infrastructure and methodologies are provided to support biasing of search query inputs based on local content, device profile and/or activity information. In some embodiments, biasing operations are performed on a search input to a client device in order to improve search result relevancy. The biasing operations produce additional search query elements/context options based on locally-hosted content and/or other information that may not be readily available to a search engine. Such content may include, for example, images, text, audio/video files, documents, code, applications, social media, etc. One or more of the additional search query elements/context options are then selected (e.g., in an automated manner or via a user selection process) to be utilized in a search query communicated to a search engine. In this manner, additional context is provided to improve the relevancy (or likelihood of relevancy) of the search results provided to the user.

In other embodiments, device activity data extracted from a client device (such as data generated by a device's sensors) may likewise be employed to refine search queries. Activity data might include, for example, a user's current location, time, motion-related data (e.g., speed, acceleration, altitude, and direction), recent and historical device interactions with websites or payment systems, etc. Translated and/or targeted and supplemental information based (at least in part) on the additional search query options may also be included in search results. In some embodiments, searching and biasing operations may be performed by an intermediary or proxy device.

As used herein, the term “web page” generally refers to a web document or other web resource that is accessible through a web browser and can be presented on a client device. Web pages, which may be retrieved from a local computer or from a remote web server can be in any format, e.g., in HyperText Markup Language (HTML) or Extensible HTML (XHTML) format, and may provide hypertext links for navigation to other web pages. Further, as used herein, the term “web document” refers to something that has a uniform resource identifier (URI) and can respond to requests by returning a representation(s) of an identified resource in a format such as HTML, JPEG or RDF. URIs are typically a string of characters used to identify and enable interaction with a web resource, and are often classified as uniform resource locators (URLs), as uniform resource names (URNs), or as both.

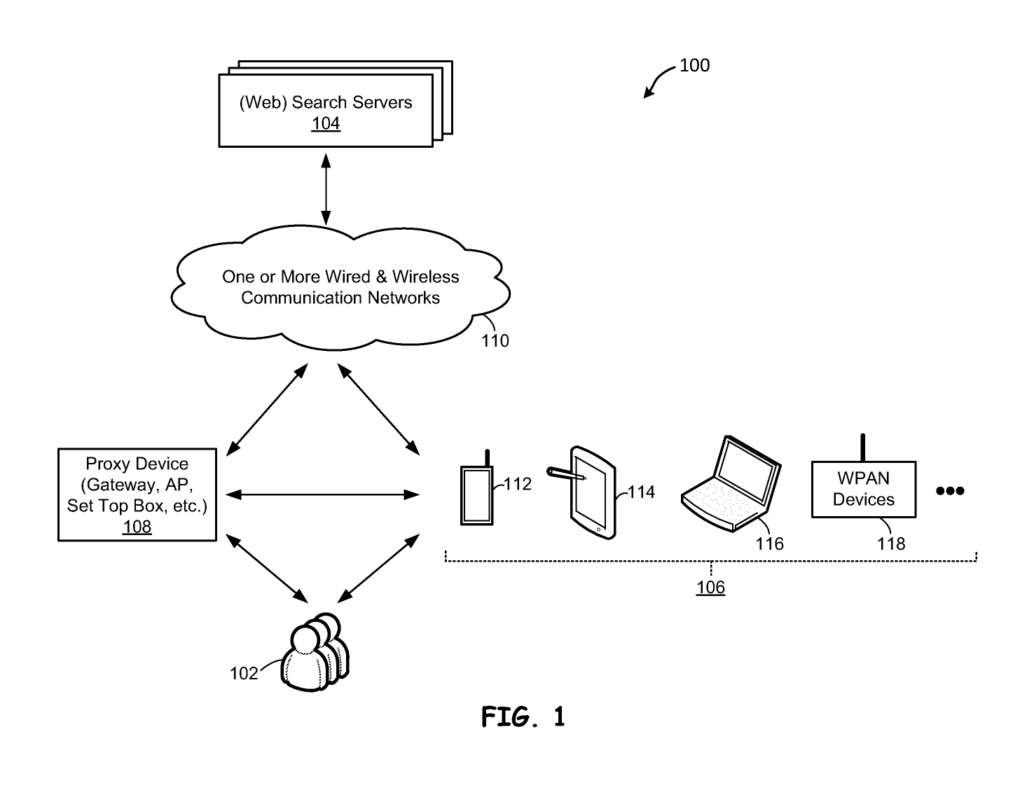

Referring more particularly to FIG. 1, a network 100 employing search result biasing functionality is shown. As shown, one or more users 102 submit search queries, receive search results and otherwise interact with search servers 104. The search servers 104 may be web-based, private or public, local, distributed or a combination thereof. The users 102 may communicate with the search servers 104 via a variety of devices or combination of devices, such as client devices 106 and intermediary or proxy devices 108.

Client devices 106 may include, for example: mobile phones/smartphones 112; tablet devices 114; desktop and laptop computers 116; wireless personal area network (WPAN) devices 118 and other wireless/wired network devices; wearable computers (e.g., heads-up display (HUD) glasses) and other known or future computing devices with communication capabilities; audio/video media consumption devices; and other types of devices capable of communicating search queries and/or receiving search results. Additionally, in certain embodiments, interactions with search servers 104—including both user-initiated and automated interactions—may involve one or more proxy devices 108, such as gateway devices, access points, STBs, etc.

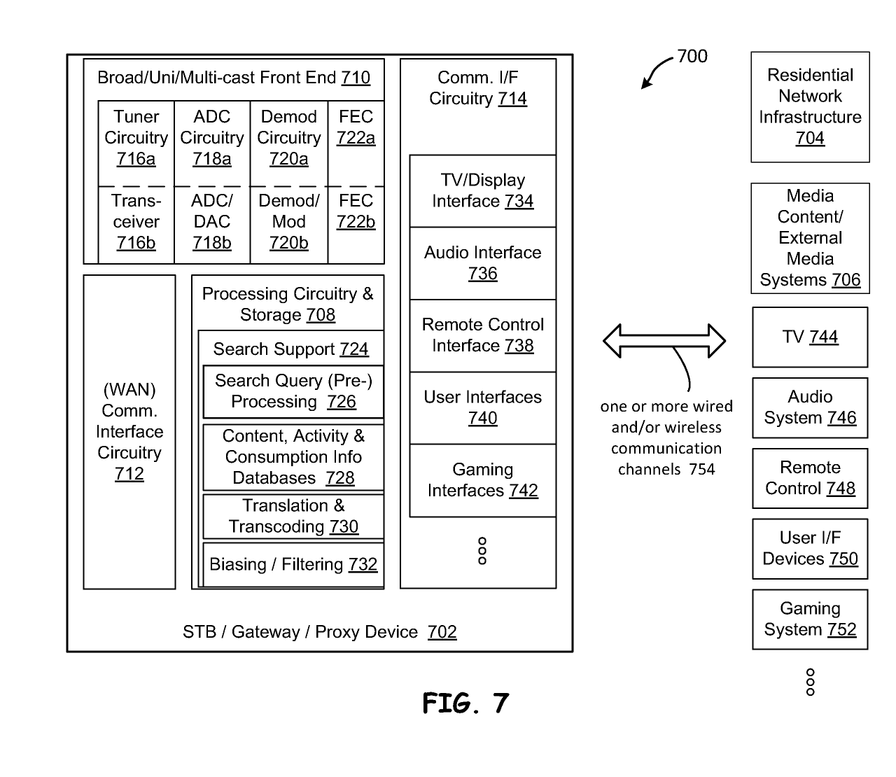

By way of example, and as described more fully below, a search query element(s) can be input through a client device 106. Pre-processing is then performed on the search query element(s) to identify correlations between the element(s) and locally-hosted content (or information derived therefrom), or otherwise provide additional context for the search query. A search query including this additional contextual information may then be communicated to the search servers 104 (e.g., via a proxy device 108 such as that described below in conjunction with FIG. 7). Search results generated by the search servers 104 may be communicated directly to a client device or through a proxy device 108 for consumption by a client device 106. In certain embodiments, a search query submitted to search servers 104 may originate from or be entered through a proxy device 108 on behalf of one or more client devices 106. In further embodiments, a proxy device 108 may operate as a client or consuming device. Biasing of search queries based on locally-hosted content may be performed by server-side devices, client-side devices, or a combination thereof.

In the illustrated embodiment, communications between the search servers 104, client devices 106 and proxy devices 108 occur via one or more wired and wireless communication links 110. The communication links 110 may utilize, for example, one or more of various transmission media—such as coaxial cable, shielded twisted pair cable, fiber-optic cable, power line wires, and wireless media (radio frequencies, microwave, satellite, infrared, etc.)—and operate in accordance with a variety of communication and networking protocols (TCP/IP, UPnP, IPv6, etc.) and standards (3G, 4G, IMT-Advanced, DOCSIS, xDSL, Wi-Fi/802.11x, WiMax, Bluetooth, etc.). In addition, the communication links 110 may comprise a picocell, femtocell, metrocell, heterogeneous network (HetNet) and/or multi-hop network utilizing a spanning tree protocol, direct wireless connections, peer-to-peer links, etc.

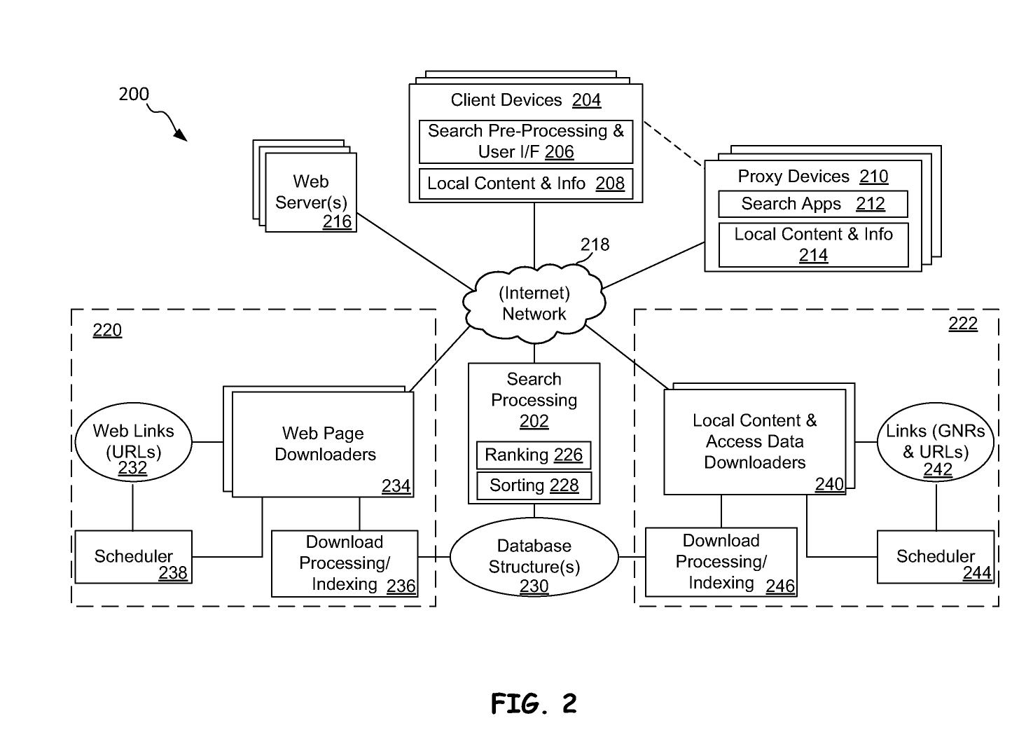

FIG. 2 is a block diagram of one example of a search system 200. The search system 200 includes client devices 204 having search pre-processing and user interface functionalities 206 capable of biasing search queries based on local content and information 208. Biasing of search queries may include, for example, appending additional search terms/elements to user-provided search terms to improve the relevancy of search results provided by search processing functionality 202.

In various additional embodiments, the illustrated search processing functionality 202 is further capable of biasing search queries and search results, e.g., based on either or both of hardware and software characteristics of client devices 204 and/or proxy devices 210. Biasing of search results may include, for example, individual ones or combinations of (re)ranking 226, sorting 228, filtering, culling, restricting, and other tailoring operations that favor search results that are compatible with or may be consumed by recipient devices, or (using predictive operations) are most likely to be consumed by recipient devices. Such biasing operations may be performed by one or more of client devices 204 and proxy devices 210 in lieu of or in addition to the search processing functionality 202.

The pre-processing and user interface functionalities 206 of client devices 204 may include search-enabled application software (e.g., a user search interface in a web browser or media player) for generating search queries and receiving search results. Similarly, proxy devices 210 can also include search-enabled software applications 212, including software to enable user-directed search query biasing operations on behalf of or for the benefit of other devices. The proxy devices 210 further include local content and information 214 relating to the proxy devices 210, the client devices 204, and/or users of such devices. In certain embodiments, the local content and information 208/214 may be identified or generated, in whole or part, through execution of scanning or diagnostic tools hosted by a client device or search infrastructure. In other embodiments, content and profile information may be supplied through or supplemented by user input operations or user profile/sub-profile information.

A web crawler 220 systematically browses or “crawls” the World Wide Web hosting servers for the purpose of building a database of web-based content. Web crawler 220 uses a list of web links 232, such as URLs, as seeds for a process of content discovery. As the crawler visits these URLs, one or more web page downloader(s) 234 parse the URLs to identify unique hyperlinks in the page which point to content stored in web servers 216. URLs are typically visited in a recursive manner according to a set of policies which detect structure and content. As links are traversed, web pages and specific content are downloaded by downloader(s) 234 as per a schedule dictated by scheduler 238.

Download processing/indexing 236 operates to perform reverse indexing of a selected web page to encode web page words (e.g., based on frequency) and note location on the associated page (offset) so that content can be recovered or extracted at a later time. The indexed data is transferred to a search engine database structure(s) 230, where it is stored for later access by the search processing functionality 202. In various embodiments of the present disclosure, search processing functionality 202 receives Hypertext Transfer Protocol (HTTP) sequences and/or user input search strings from a client device 204 (e.g., smartphone, tablet, laptop, desktop computer or other known or future client devices with communications capabilities) and/or proxy device 210 parses/hashes database structure(s) 230 to retrieve, for example, data, text, images, video, software, links, etc., and to tailor/bias search queries and/or search results.

Briefly, database structures 230 typically include indexes of unique words with associated index pointers (URLs) and web page position information. Unique words are hashed using a hash table. A hash table (or hash map) is a data structure used to implement an associative array, a structure that can map keys to values. A hash table uses a hash function to compute an index into an array of buckets or slots, from which the correct value can be found. Unique words are typically arranged by frequency (e.g., highest to lowest) and also carry importance based on a frequency ranking. In a search context involving the phrase “the cat”, for example, the word “the” is generally not important while the word “cat” is important. Rare words are often given highest importance along with strings of words and rare strings of words.

Various elements of search system 200 are interconnected by a network 218 (e.g., an Internet backbone network) that is implemented using known and future communication infrastructures such as wireless and wired networks including, but not limited to, wireless local area networks (WLANs), wide area networks (WANs), local area networks (LANs), Ethernet, fiber optic or other known or future communication network infrastructures. Web servers 216 are accessible via the network 218, and host various web pages and associated content processed by the web crawler 220 and the search processing functionality 202.

A local crawling system 222 may also be provided to access and (pre-) process local or private content in support of searching and biasing operations. Such local content might include, for example, personal media libraries or image databases, backup files and cached content, content stored on networked devices, virtual tag content and access data, etc. This content may or may not be available in a markup language format, e.g., HTML or XHTML, and may not be readily accessible by the search processing functionality 202.

In operation, the local crawling system 222 performs in a like manner to the web crawler 220. In one example involving virtual tags, the local crawling system 222 can access and parse stored geolocation virtual tags in much the same way a traditional web crawler would crawl a web page. The illustrated local crawling system 222 includes, but is not limited to: one or more local content and access data downloader(s) 240; links or pointers 242 (such as URLs or global network routes (GNRs)) which identify unique routes that will guide a future search request to relevant content or portions of content; scheduler 244 to schedule the crawling of the local or client-hosted content; and download processing/indexing 246 to process and (reverse) index data and content for storage in databases such as database structure(s) 230 accessible by client devices 204 and/or search processing functionality 202.

Pre-processing of local content includes, in various embodiments, classification by type, category, and/or function (e.g., video, social media, paid content, etc.). More specifically, the content may be traversed and indexed for use in search query biasing operations. Depending on the content type, pre-processing operations may generate one or more of: (i) indexing data; (ii) digital signature data; (iii) content (e.g., image) characteristic data; (iv) translated (transcoded, resized, reformatted) versions of the original content; (v) the original content; (vi) meta data associated with the original content; (vii) security related data; (viii) user/group profile related information; (ix) user interaction data; (x) popularity related information; (xi) associated text (e.g., surrounding text for images, code, video, audio), etc.

Pre-processing of images, for example, might include extracting non-text information such as whether the image is black and white, a sketch, drawing file, full color, a photograph, or clip art, facial recognition information, age/sex identification (adult, child, senior, male, female, etc.), etc. In addition, in some embodiments, access information is extracted such as public/private rights, sharing lists, grouping, download and distribution rights, security requirements, or access based on income, gender, age, location, citizenship, relationships, memberships, etc.

Once new content is created by a client device 204, the content may be stored locally (e.g., on the client device 204 with an associated pointer to the content) or remotely (e.g., using the search infrastructure and/or in the cloud-based servers). Content created by a client device 204 may include, without limitation, original content, downloaded content or aggregated content. In certain embodiments, each client device 204 pre-processes its own content. The actual content may be uploaded thereafter in one or more processed formats, maintained locally within client devices 204 or proxy devices 210, or some combination thereof.

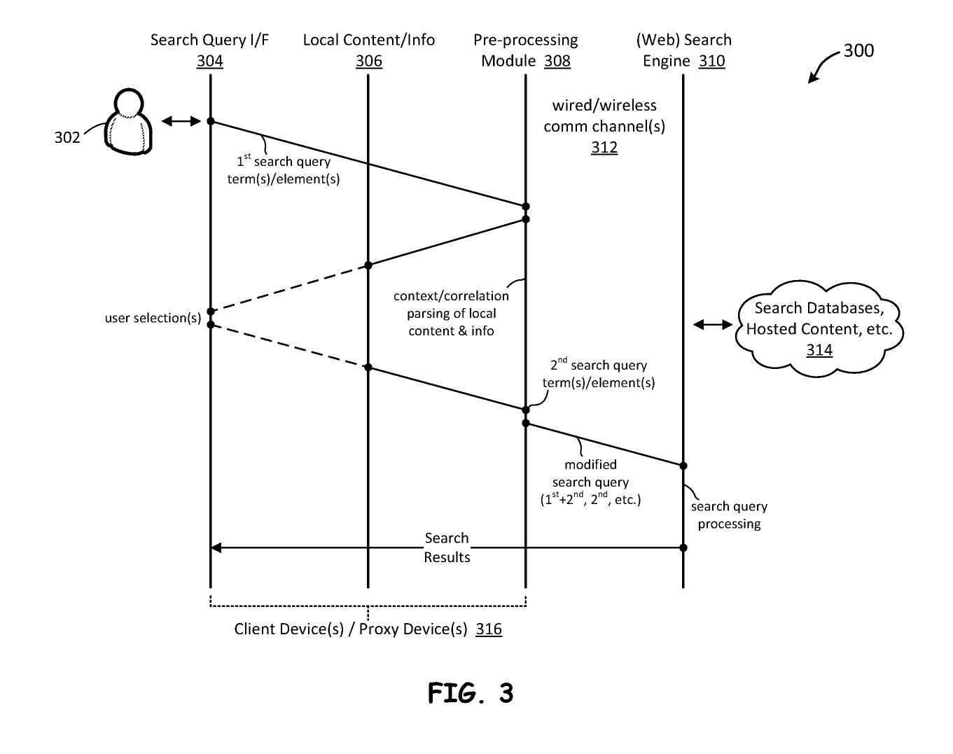

FIG. 3 is a state diagram depicting exemplary user interaction with a search infrastructure 300. In the illustrated diagram, a user 302 initiates a search query by entering or selecting a first search query term(s)/element(s) via a search query interface 304 such as may be provided by a search-enabled software application, web browser, or the like. In other embodiments, the pre-processing module 308 may be configured to automatically select an initial search query term/element, such as when operating in a background or predictive search mode.

The first search query term(s)/element(s) is utilized by a pre-processing module 308 to identify additional search query terms/elements based on context/correlation type parsing operations of local content/information 306 (or indexed representations thereof). As represented by dashed lines, a user selection process may be employed in certain embodiments in which a user participates in the process of identifying one or more second search query term(s)/element(s). All of the foregoing steps might be performed, for example, by one or more client devices or proxy devices 316.

Next, the pre-processing module 308 or related functionality generates a search query utilizing one or more of the identified/selected additional search query term(s)/element(s). The search query may or may not also include the first search query terms. The search query is communicated via wired or wireless communication channel(s) 312 to a (web) search engine 310 for search query processing. Such processing may involve various search databases, including centralized search databases, hosted content, etc. 314. Corresponding search results are then communicated back to the user/proxy device(s) 316 via the communication channel(s) 312.

Pre-processing of search operations as described allows a great deal of local content and software on a user/client device—including content that may not be hosted elsewhere—to be leveraged to bias search queries. For example, a user's private photographs of his/her family might be processed locally to identify common characteristics of family members. This information may then be stored in private local search databases. Later, the user might indicate a desire to search using a single photograph of his/her son. Instead of merely uploading the photograph to a search engine, the photograph may be pre-processed and compared to other stored images.

Utilizing the results of such comparisons, a modified search query (or search package) can then be prepared. Such query may include, for example, one or more images (which may or may not include the initial photograph), image related characteristics data extracted from multiple similar photos of the son, tags or facial recognition operations that provide the son's name or other identification information, etc. Using the modified search query, a search infrastructure may be able to more readily converge on an appropriate result. Thus, local content and information can be identified, pre-processed and used to tailor, predict, or bias a search so as to yield higher quality search results.

A similar process may be utilized when searching for an individual by name. Simply submitting a name to a traditional web search engine may require iterative searching to narrow a large set of initial results. Instead, upon identifying a first name, last name and/or portion of a name as a first search element, the client device may be configured to parse local or locally accessible content for other occurrences of the name, including content such as documents, tags, data extracted from images in a photo directory, other relevant local content (e.g., storage area network (SAN) content), etc.

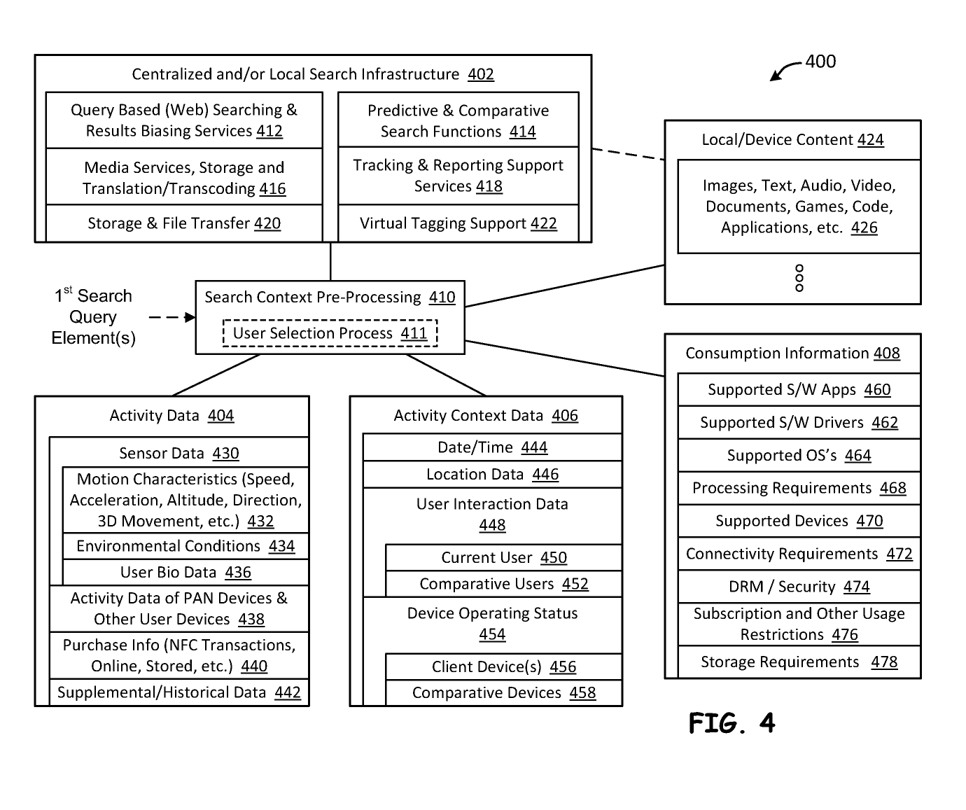

FIG. 4 illustrates an exemplary search engine infrastructure 400 employing search context pre-processing. In the illustrated embodiment, a centralized client/server or local/distributed search infrastructure 402 processes search queries (e.g., from a client device) that may include search elements identified or generated by search context pre-processing 410 using a variety of device content and other data as described below.

The search infrastructure 402 of this embodiment provides query based (web) searching and results biasing services 412 and predictive and comparative search functions 414. The search infrastructure 402 may include additional functionality to support search result biasing and related operations, including media-related services (such as media file storage and translation/transcoding functions) 416 and tracking and reporting support services 418 (e.g., for managing activity data 404 and activity context data 406). The search infrastructure 402 further supports general storage and file transfer services 420, such as caching of device hosted content, as well as virtual tagging support 422.

In this embodiment, search context pre-processing 410 utilizes one or more of local or device content 424 (“local content 424”), activity data 404, activity context data 406 and consumption information 408. In operation, search context pre-processing 410 identifies correlations/associations between such content/information and a first search query element(s), and may further generate predictive search terms based on a first search query element(s). The first search query element may be provided by a user through a search query or browser interface, selected from the web or local content, etc.

A user may establish predefined rules or guidelines for establishing associations between search query inputs and local content/information to identify context elements for biasing a search query. A variety of confidence levels might be employed or selected, for example, to reflect a user's confidence in an initial query term, power consumption considerations, availability of processing resources, time of day, location, etc. In some embodiments, an upper or lower limit may be placed on the number of context elements/secondary search elements used to bias a search query. In still further embodiments, a user selection process 411 may be provided to allow manual selection of available context elements.

In the illustrated embodiment, activity data 404 and/or activity context data 406 is provided by or otherwise extracted from a client device to help enable more accurate user activity predictions and to refine or supplement search queries and/or results. Such data may include sensor data 430, such as motion characteristics/data 432 (e.g., speed, acceleration, latitude, direction, three dimensional movement, etc.), environmental conditions 434 (e.g., temperature and humidity), user biometric data 436, etc. Other relevant activity data 404 may include activity data 438 relating to PAN devices and other devices associated with a user, purchasing information 440 (e.g., prior NFC transactions and online/stored purchase histories provided by various websites), and other supplemental and historical data 442. Activity context data 406 may include, e.g., one or more of the following: data and time information 444, location data 446 (e.g., from a device GPS module, media access control (MAC) address, Internet protocol (IP) address, or the like), prior user interaction data 448 (for a current user 450 and/or comparative users 452), and current and historical device operating status data 454 (for a given client device(s) 456 and/or comparative client devices 458).

For example, sensor data 430 can be utilized in predictive search operations to bias or to trigger a search query. Such prediction might involve, for example, detecting that when a user captures images with a smartphone on weekends while walking, the images typically involve architectural content. If the user tends to launch an image search shortly thereafter, he/she may generally favor certain photo sites for viewing matching images. Based on such correlations, if the user is walking, e.g., through a city, and captures an image, the smartphone may be configured to immediately pre-process the image for search querying, including identifying similar images and associated information for use in search query biasing operations.

If the user then opens or begins interacting with a search query interface, the smartphone may begin uploading the image and/or any identified context elements while prompting the user for confirmation that such image is to be utilized in searching. If the user confirms, the image upload may continue, and the resulting search results can be biased to favor the preferred photo sites. It is noted that motion characteristics 432 and other sensor data 430 can be used in tailoring search queries associated with any type of searching (virtual tags, normal web searching, predictive search result production, etc.).

In another example in which context regarding a user's activity is derived from a particular device over time, a set top box might provide details regarding a user's Thursday night viewing and search habits (e.g., preference for a particular science fiction series). Over time, by merely pulling up a search query interface provided by the set top box, results (which may be pre-downloaded) including the preferred television series may be offered.

In still further embodiments, consumption information 408 is compiled for searchable data files and/or client devices for use in search query biasing operations. Without limitation, such information may relate to supported software applications 460 and supported software drivers 462, supported operating systems 464, processing requirements 468, supported devices 470, connectivity requirements 472, digital rights management (DRM) and other security requirements 474, subscription-based requirements and other usage restrictions 476, storage requirements 478, etc. A distributed compilation approach may be employed wherein consumption information 408 (and/or local/device content 424) is gathered by a web server or client device. This consumption information (and possibly data files themselves and/or translations thereof) may then be delivered, if desired, to a central search database structure through a centralized crawling process or via push/pull operations.

As noted, the search context pre-processing 410 may utilize local content 424 to identify (through, e.g., correlations or associations) secondary or context items/options for use in biasing search queries. Such local content 424 may include, by way of example and without limitation, images, text, audio files, video files, documents, games, software code, applications, etc. 426. Such content may be stored in one or more client devices, proxy/intermediary devices, networked devices, Internet or cloud-based servers/storage/caching or the like, or some combination thereof. In some instances, such content may be inaccessible or hidden from a centralized search engine.

Local content 424 may be pre-processed and classified (e.g., for indexing) using, for example, “Internet media types” or “MIME types”, which refer to standardized identifiers for file formats on the Internet. A media type is generally comprised of two or more parts, including a type and a subtype (such as video/mpeg), and are defined in HTML by the “type” attribute on links, objects, and script and style tags. Media types defined by MIME standards include image, text, video, audio, application, message, model, etc.

In addition to the explicitly illustrated data and content examples, a wide variety of data relating to a user or a user's device may be utilized in search query and search result biasing operations. For a particular user, for example, blogs, web articles, scholarly articles, patents, etc., and any other web presence information available on the Internet may be utilized to assist in biasing/tailoring/predicting search queries and/or results.

Likewise, a device may have associated web presence data. For example, device information associated with a profile might be used to identify other web-hosted data that provides further device details, usage patterns, etc. In one example, a group of similar devices that have been used in a similar manner can be identified and used to tailor, predict, or bias a search so as to yield higher quality search results.

Further, a user may establish a search profile that can be applied to bias search queries and/or search results. In one example, a user may initiate a search on a mobile device during the day while at work. Based on time, location, and other environmental data, pre-processing can be performed to identify search query context elements likely to result in work-oriented search results. For example, data from a work calendar might be leveraged while searching during work hours. Conversely, when searching at night, data from social networking profiles, personal email accounts, files in a private directory, and the like might be utilized in a biasing process that favors non-work related results.

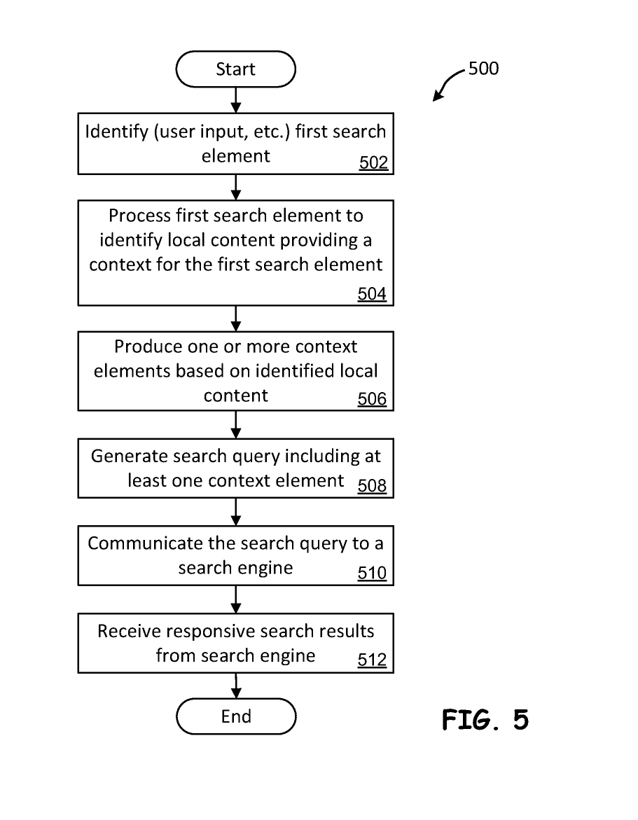

Referring now to FIG. 5, an operational flow diagram of an exemplary method 500 for utilizing device content to bias a search query is illustrated. In this method, a first search element, such as a search query term input by a device user, is identified by (or to) search context pre-processing functionality (502). The first search element is then processed (504) to identify local/device content providing a (potential) context for search queries based on the first search element. One or more such context elements are then produced or otherwise generated for use in biasing a search query (506).

Next (508), a search query including at least one context element is generated. In various embodiments, the search query may include the first search element and multiple context elements, context elements only, etc. The search query is then communicated to a search engine (510). Responsive search results are received from the search engine (512). In certain embodiments, the search engine may be a “metasearch engine” that forwards user search queries to several other search engines and/or databases and aggregates the search results into a single list or displays the results according to source.

Supplemental and/or locally hosted information may also be appended to or identified within the search results. Such information may include, for example, targeted advertising based on device and/or user profile information, alternate search results, etc. It is also noted that device profile information may be refreshed or expanded following receipt of a search query.

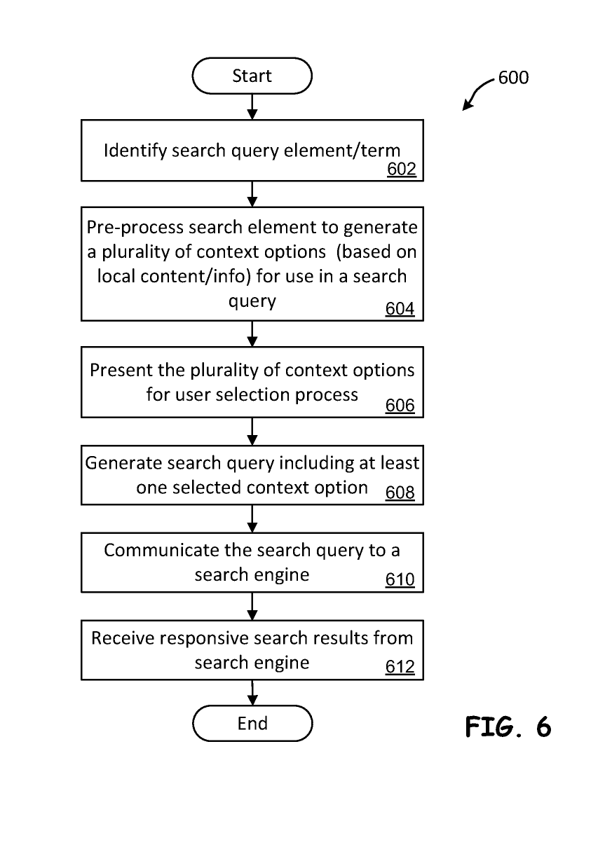

FIG. 6 is an operational flow diagram illustrating an exemplary method 600 for interactively biasing a search query with locally-hosted content. In this method, a first search query element/term is identified by (or to) a search context pre-processing module (602). The first search element is then processed (604) to generate a plurality of context options (e.g., based on local/device content) for use in biasing a search query.

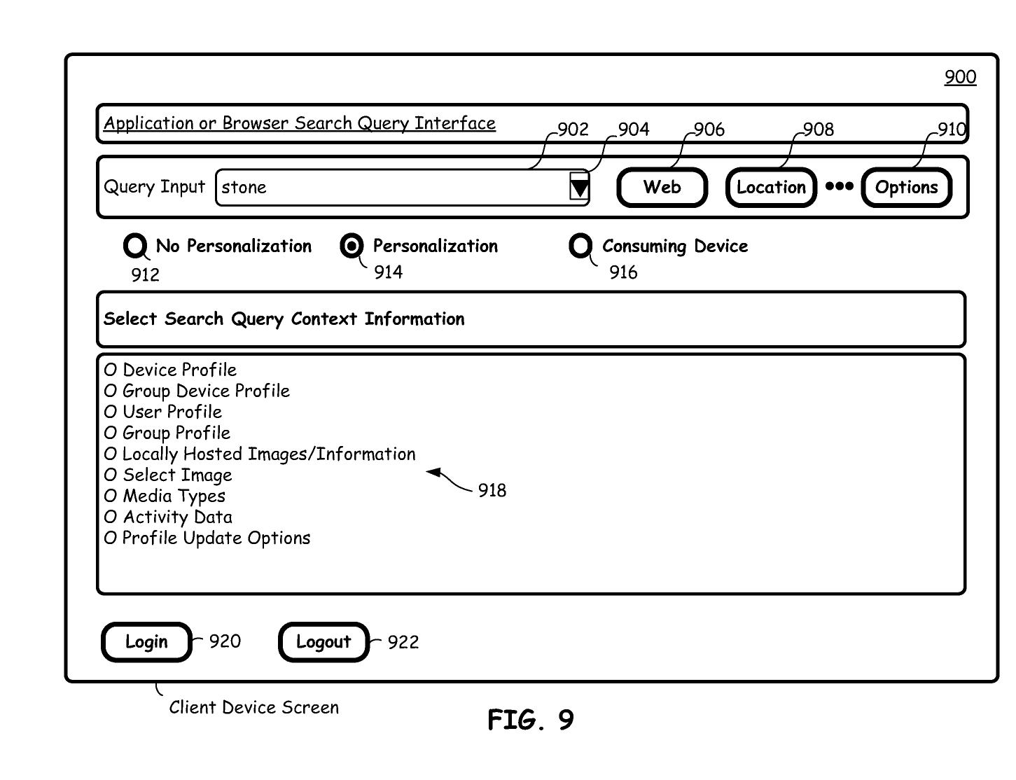

Next (606), the plurality of context options are presented to a user for selection. Selection of context options may occur, for example, via a user interface such as described in conjunction with FIG. 9. A search query including at least one selected context element is then generated (608). In various embodiments, the search query may include the first search element and multiple context element selections, selected context elements only, etc. The search query is then communicated to a search engine (610). Responsive search results are received from the search engine (612).

In further embodiments according to the disclosure in which a user or client device initiates a search, search processing may entail use of real time or stored client device capability information to impact biasing of search queries and/or results. For example, a search query using the word “Stones” from a device representing a user's DVD player might include information relating to the DVD player make and model, system speaker configuration and video capabilities, a home network arrangement, supported standards, user configuration data, etc. That is, the search input could be “Stones” plus one or more items of system capability information. In addition, system usage history (overall or per family member user) might also be conveyed (e.g., title, artist, year, consumed history, consumption frequency, etc.). This information may be submitted along with a search query, or stored and periodically updated by a central search infrastructure.

In the latter approach, the search query might include the term “Stones” along with device and/or user identification information. The search infrastructure may then only need to access the device's profile information (and possibly user profile information) in order to return search results that are tailored for the particular device or current operating environment of the device.

In other embodiments wherein first devices are configured or authorized to pair with certain second devices, search queries may be biased to promote selection of such pairings via Internet pathways. Such first and second devices may both be clients or servers, or combinations thereof. For example, profile information may allow pairing of an STB, DVD carousel player, NAS media server and like devices to one or more smartphones, e.g., belonging to one or more family members, for slinging-type operations. In such an example, a family member might then visit a search site, enter a query for “stone,” select his/her smartphone as the consuming device, select personalization (or user profiling) options, and then submit the search query.

In this example, responsive search results might favor a “Rolling Stones” CD offer via a DVD carousel player, an “Oliver Stone” movie via a NAS media server, and then a collection of Internet-hosted items that can be consumed by the family member's smartphone. By further selecting to restrict the search results to “software programs,” biasing/filtering operations yield different search results where, for example, a Rosetta Stone language translation application tailored for the searcher's native tongue, geolocation, and smartphone are offered near the top of the search results. If the consumption type is changed to “spreadsheet”, search results might favor or highlight a price list (in spreadsheet format) from a natural stone sales site, along with an offer for a spreadsheet application or other compatible reader application tailored for the relevant smartphone. The searcher may elect to download the application with or without the actual content, or vice versa. If a local application capable of consuming relevant content is already present, this information may also be used to tailor search queries targeting such content and/or filter search results. Thereafter, by selecting the content, the application could be launched (or downloaded from a local source if not already present). Payment infrastructure and/or DRM licensing management may also be present and supported within the search infrastructure.

FIG. 7 is a functional block diagram representation of an exemplary residential network 700 supporting search query biasing operations. A device 702, such as a communication device, STB or gateway, provides a number of search support functions, and may operate as a gateway or intermediary device that supports unidirectional or bidirectional search-related communications and bridging between client/network devices.

The device 702 interacts with a residential network infrastructure 704 and external media systems 706 via one or more wired and/or wireless networks/links 754. The networks/links 754 may utilize one or more of various transmission media—such as coaxial cable, shielded twisted pair cable, fiber-optic cable, power line wires, etc.—and operate in accordance with a variety of communication and networking protocols (TCP/IP, UPnP, IPv6, etc.). In addition, the networks/links 754 may comprise a multi-hop network utilizing a spanning tree protocol, direct wireless connections, peer-to-peer links, etc.

The external media systems 706 may comprise, for example, one or more of cable, satellite and/or terrestrial televisions systems. Various headend equipment and services can be utilized by these systems, such as a cable headend that receives television signals for further processing and distribution, and may offer various other services such as Internet connectivity (e.g., to external search infrastructures) and VoIP services.

The device 702 of the illustrated embodiment includes a broadcast/unicast/multicast front end 710 that operates in part to communicate search queries to and receive search results from search service providers. The front end 710 further operates to receive uncompressed and/or compressed digital video, digital audio and other data signals, from either or both of the external media systems 706 and residential network infrastructure 704, for further processing and distribution. The front end 710 comprises tuner circuitry 716a operable to isolate particular channels. Signals from the tuner circuitry 716a are provided to analog-to-digital (ADC) circuitry 718a and demodulation circuitry 720a for conversion into binary format/stream. Further, forward error correction (FEC) circuitry 722a can check the integrity of the received binary stream. Audio, video, and data extracted from the binary stream may be decoded (e.g., by search support 724) into one or more formats suitable for consumption by downstream devices. It is noted that demodulation circuitry 720a may support one or more modulation techniques, such as Quadrature Phase Shift Keying (QPSK), Quadrature Amplitude Modulation (QAM), Coded Orthogonal Frequency-Division Multiplexing (COFDM), etc.

The front end 710 may be integrated into one or more semiconductor devices that may further support, for example, interactive digital television, networked DVR functionality, IP video over DOCSIS applications, and 3D graphics support. In addition, multiple tuner circuitry 716a (including in-band and out of band tuners), ADC circuitry 718a and demodulation circuitry 720a may be provided for different modulation schemes and television standards (such as PAL, NTSC, ATSC, SECAM, DVB-C, DVB-T(2), DVB-H, ISDB, T-DMB, Open Cable).

In some embodiments, functionality of the device 702 is performed by a smartphone or mobile computing device (e.g., a tablet device or laptop computer). In such embodiments, the “front end” 710 comprises one or more wireless interfaces (including PHY and baseband functions), such as a cellular (3G, 4G, IMT-Advanced, etc.) or wide area network (HetNet, Wi-Fi, WiMax, etc.) interface. The interface may support one or more modulation and multiplexing techniques, such as OFDM, OFDMA, SC-FDMA, QPSK, QAM, 64QAM, CSMA, MIMO, etc. In the illustrated embodiment, the wireless interface comprises a transceiver 716b, analog-to digital (ADC) and digital-to-analog (DAC) circuitry 718b, demodulation and modulation circuitry 720b and FEC (such as turbo codes or LDPC codes) circuitry 722b.

The illustrated device 702 also includes WAN/LAN communication interface circuitry 712 for communicating with residential network infrastructure 704 and/or external media system 706. Through the communication interface circuitry 712, the device 702 may communicate directly with external searching services and other upstream resources, or offer (bidirectional) bridged communications between such resources and devices coupled to the device 702.

In the example of FIG. 7, device 702 interacts with a variety of devices 744-752 over one or more wired and/or wireless communication channels via communication interface circuitry 714. For example, a television or display interface module 734 communicates with a (digital) television 744 or other media display device to relay television programming and enable available interactive services. In certain embodiments, the television or display interface module 734 might include a remote user interface (RUI) server. Similarly, an audio interface 736 provides audio programming or audio library access to an audio system 746.

The communication interface circuitry 714 further comprises a remote control interface 738 for receiving control signals from a remote control 748. In addition to traditional remote control operations, the remote control 748 may further offer voice and/or gesture control signals that are relayed or mapped to relevant consumer devices. User interfaces 740 are also provided for communications with one or more user interface devices 750. Gaming interfaces 742 function to provide interactive communications with a gaming system 752. Such communications may involve, for example, online, multiplayer gaming between members of a social network and/or external players in a gaming platform. As will be appreciated, various devices 744-752 may support full or limited search querying and/or search result consumption capabilities.

The device 702 includes processing circuitry and storage capabilities 708 (components of which may be comprised of hardware, software, or combinations thereof) to support searching and biasing operations. In particular, search support functionality 724 may be provided, including various functions such as search query (pre-) processing 726, content, activity and (device or data file) consumption information databases 728, translation/transcoding functionality 730, and search query/result biasing and filtering capabilities 732. In operation, such search support resources 724 enable the device 702 to function as an intermediary device capable of biasing search queries, reformatting received search results, filtering or otherwise biasing search results (including partial or additional biasing), assisting in translation services for end point consumption devices, managing DRM and payment collection, etc. It is noted that the processing circuitry and storage capabilities 708 may be made available in whole or part as a resource for external service providers, networked devices, etc.

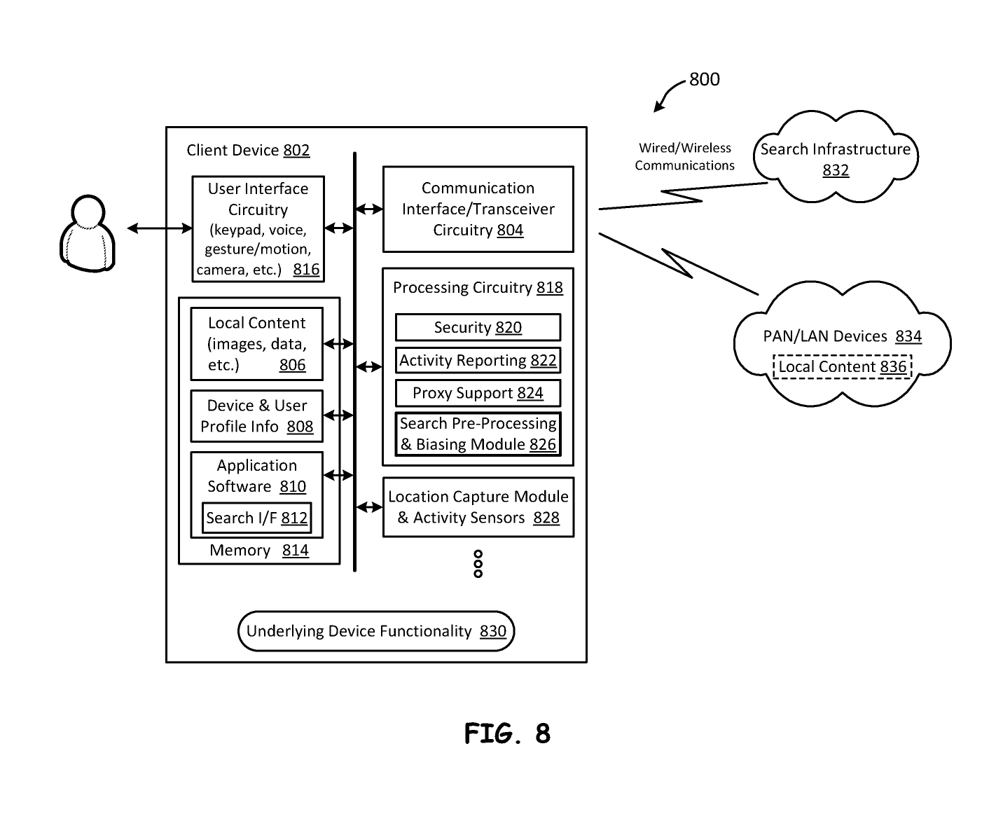

FIG. 8 is a schematic block diagram of an example client device 802 that supports search query biasing operations. The client device 802 is shown in a wired and/or wireless network 800 that includes a search infrastructure 832 and one or more personal area network (PAN)/LAN devices 834 (which may host local content 836). The client device 802 communicates with such elements of the network 800 via communication interface and transceiver circuitry 804. These communications may be unilateral or bidirectional/interactive, and may utilize proprietary and/or standardized communication protocols. Communications may include, for example, search queries and search query results, profile and activity information, control signals, audio/video content, relayed information, etc.

The client device 802 of the illustrated embodiment further includes processing circuitry 818 operable to process and manage search query biasing operations such as those described above. More particularly, the processing circuitry 818 may include, for example, a security module 820, an activity reporting module 822, a proxy support module 824, and a search pre-processing and biasing module 826. The client device 802 further includes location capture module and activity sensors 828 in order to generate activity data for use in search query/result biasing operations, virtual tagging functions (such as described above), etc. A location capture and activity sensors module 828 may include, for example, GPS capabilities, Wi-Fi positioning support, or other technologies capable of generating device location information.

The client device 802 further includes local content (images, data, etc.) 806, device and user profile information 808, and application software (or program code) 810 providing one or more search interfaces 812. Each of elements 806-810 may take many forms, and is maintained in static or dynamic memory 814. As noted, device and user profile information 808 enables a client device to present an image of itself and/or its capabilities for use in performing various search query or search result biasing operations. Depending on the capabilities and requirements of a particular device or device user, a device or user profile may be static or dynamic.

In certain embodiments, the client device 802 may interact with a user(s) via user interface circuitry 816. User input to the client device 802 may include, for example, search query data entry through a keypad, touchscreen, remote control device, gaming controller, device control buttons, voice or gesture commands, camera, storage device, etc. Authorized access to or control of the client device 802 can be facilitated through unique biometric identifiers, passwords, token-based identification, trusted authorities or documents such as a driver's license or passport, and like authentication mechanisms.

The client device 802 may perform core or underlying functionality 830 (e.g., social networking functions, social appliance functions, mobile communications, security, vehicular communications, etc.). Alternatively, the client device may primarily function as a search interface and/or search result consumption device.

FIG. 9 is a screen shot illustrating an exemplary search query interface 900 supporting user-specified biasing operations. The search query interface 900 may be presented on a client device screen (e.g., smartphone or tablet device), on a display incorporated in or attached to a proxy device (e.g., a set top box), or on other types of devices capable of performing search query operations. Further, the search query interface 900 may be a stand-alone application or program code, part of a larger client device software application/program code or a hosted/cloud-based application, displayed through a web browser, etc.

In the illustrated configuration, the search query interface 900 includes a query input field 902 for entering search query elements/terms (text, images, etc.). A drop down menu 904 may be included to allow a user to select previous search queries, suggested search queries, and the like. Option buttons 906-910 are provided to allow a user to specify search parameters, such as web-based button 906 and location-based searching button 908. Other searching parameters may be presented to a user by clicking option button 910.

With respect to biasing of search queries, various fields or radio buttons are provided to allow a user to select traditional searching (no personalization) 912 or personalization (biased search querying) 914. In some implementations, biasing of search queries/results may be automatically performed, e.g., based on a preference election. An additional radio button 916 may be provided to allow a user to selectively provide an indication (e.g., through a sub-menu) of consumption capabilities and user preferences associated with an intended recipient or consuming device for use in biasing (or further biasing) of search queries and/or search results.

For example, the search query interface 900 may be displayed on a laptop computer, but the user may select to tailor search queries and/or search results to favor items capable of being displayed by a particular television or other media consumption device. By clicking on such search results, a user may be offered: a version of an item formatted for the consumption device; secure payment processing; direct delivery to a consuming device; indirect/proxy delivery through the laptop or other device; software and/or software upgrades (operating system, applications, drivers, etc.) required to consume an identified item; associated consumption metadata including ratings, descriptions, consumption information, etc.; and opportunities to rank or socially link an item.

In the illustrated embodiment, in which personalization 914 of search queries is selected, the user is presented with a variety of search query bias information options 918 for use in adding context text to search queries and/or biasing search results, including real time, predictive and/or background searching operations. Such bias information options may include, by way of example and without limitation, one or more of device profile information, group device profile information, user profile information, group profile information, locally hosted images/information, selected images, media types, activity data, etc. The search query interface may be configured to support selection of other types of data, such as those described in conjunction with FIG. 4. Selection of a given option may result in display of additional or related options, such as a sub-menu that allows selection of one of a plurality of available context elements identified in response to an initial or preliminary search term entered by a user.

Other possible elements of the search query interface 900 include a login option button 920 (e.g., for accessing a specific user account) and a logout option button 922. It is noted that the specific look and feel of the search query interface 900 is not considered critical, and many variations in both presentation and range of options are possible.

As may be used herein, the term “associated with”, includes direct and/or indirect association of separate items and/or one item being embedded within another item. As may also be used herein, the terms “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions/program code. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributed (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the operations and/or functions illustrated in one or more of the Figures. Such a memory device or memory element can be included in an article of manufacture.

The present disclosure includes method descriptions illustrating the performance of specified functions and relationships thereof. The boundaries and sequence of these functional building blocks and method operations have been defined herein for convenience of description. Alternate boundaries and sequences can be defined so long as the specified functions and relationships are appropriately performed. Any such alternate boundaries or sequences are thus within the scope and spirit of the claims. Similarly, flow diagram blocks may also have been defined herein to illustrate certain significant functionality. To the extent used, the flow diagram block boundaries and sequence(s) could have been defined otherwise while still performing the certain significant functionality. Such alternate definitions of both functional building blocks and flow diagram blocks and sequences are thus within the scope and spirit of the claimed subject matter. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present disclosure may have also been described, at least in part, in terms of one or more embodiments. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contrary, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present disclosure. A module includes a processing module, a functional block, hardware, and/or software stored on memory for performing one or more functions as may be described herein. Note that, if the module is implemented via hardware, the hardware may operate independently and/or in conjunction with software and/or firmware. As used herein, a module may contain one or more sub-modules, each of which may also contain one or more sub-modules.

While particular combinations of various functions and features of the present disclosure have been expressly described herein, other combinations of these features and functions are likewise possible. The present disclosure is not limited by the particular examples disclosed herein and expressly incorporates these other combinations.

What is claimed is:

1. A method for biasing a search query, the method comprising:
identifying a first search element;
processing the first search element to produce a second search element, the second search element providing a context for the first search element;
communicating a search query to a search engine, the search query including at least the second search element; and
receiving search results from the search engine, the search results responsive to the search query.

2. The method of claim 1, wherein the second search element is derived from locally-hosted content or information.

3. The method of claim 2, wherein the search engine is a web-based search engine.

4. The method of claim 1, wherein the first search element includes a search term entered by a user of the computing device.

5. The method of claim 4, wherein the second search element includes at least one image.

6. The method of claim 4, the search query further including the first search element.

7. The method of claim 1, wherein the second search element includes information derived from at least one image hosted by the computing device.

8. The method of claim 1, further comprising:
receiving targeted advertising information from the search engine in conjunction with the search results, the targeted advertising information based, at least in part, on the second search element.

9. The method of claim 1, wherein the search engine is a metasearch engine.

10. A method for use by a client device, the method comprising:
identifying a search element;
performing pre-processing of the search element to generate a plurality of context options for use in a search query;
presenting the plurality of context options for use in a user selection process that identifies at least one of the plurality of context options; and
communicating the search query to a search engine, the search query including at least one of the context options identified in the user selection process.

11. The method of claim 10, further comprising:
receiving search results from the search engine, the search results responsive to the search query.

12. The method of claim 10, wherein the plurality of context options are derived from locally-hosted content or information.

13. The method of claim 11, wherein the plurality of context options includes at least one image.

14. The method of claim 10, wherein the search engine is a web-based search engine.

15. The method of claim 10, wherein the search element includes at least one search term generated by a human.

16. The method of claim 10, wherein the search element is generated by an automated process.

17. The method of claim 10, wherein pre-processing of the search element to generate a plurality of context options is performed, at least in part, by an intermediary device.

18. A device, comprising:
a communication interface configured to support communications with a search infrastructure;
processing circuitry operably coupled to the communication interface;
memory coupled to the processing circuitry, the memory configured to store local content;
program code stored in the memory, wherein the processing circuitry operates according to the program code to provide a user interface configured to support entry of a search query term for submission to the search infrastructure; and
a search pre-processing module coupled to the memory and operable to identify the local content having potential relevance to the search query term.

19. The device of claim 18, wherein the processing circuitry further operates according to the program code to append the local content, or information derived therefrom, to the search query term to generate a search query.

20. The device of claim 19,
the user interface further configured to enable a user to select the local content identified by the search pre-processing module for use in generating the search query.
